(19) United States
(12) Patent Application Publication
(10) Pub. No.: US 2011/0011426 A1
(43) Pub. Date: Jan. 20, 2011

(54) PART WASHER AND PART WASHING METHOD USING THE SAME

(76) Inventor: Sungil KIM, Yeoju-gun (KR)

Correspondence Address: CANTOR COLBURN LLP, 20 Church Street, 22nd Floor, Hartford, CT, 06103, US

(21) Appl. No.: 12/623,072

(22) Filed: Nov. 20, 2009

(30) Foreign Application Priority Data
Jul. 17, 2009 (KR) 10-2009-0065214

(51) Int. Cl. B08B 5/00; B08B 3/00

(52) U.S. Cl. 134/31; 134/198

(57) ABSTRACT

Disclosed herein are a part washer and a part washing method using the same. The part washer includes a condensing unit which condenses VOC gas, thus markedly reducing the density of VOC gas in a chamber.

### CROSS-REFERENCE TO RELATED APPLICATION(S)

This application claims priority to Korean Patent Application No. 10-2009-0065214, filed Jul. 17, 2009, and all the benefits accruing therefrom under 35 U.S.C. §119, the entire disclosure of which are incorporated herein by reference for all purposes.

### BACKGROUND

1. Field

The present invention relates generally to part washers using an organic solvent and part washing methods using the same and, more particularly, to a part washer which is constructed such that the density of VOC gas of volatile organic compounds discharged to the air is minimized by condensing the VOC gas and passing the VOC gas through a filter, and a part washing method using the part washer.

2. Description of the Related Art

Generally, in industrial sites, for example, in vehicle maintenance shops, volatile organic compounds (VOCs) are used to remove oil stains from various parts. The VOCs are in a liquid phase (hereinafter, VOCs in a liquid phase are referred to as an ‘organic solvent’) or in a gas phase (hereinafter, VOCs in a gas phase are referred to as an ‘VOC gas’). VOCs cause air pollution, are carcinogenic substances, and are substances which induce global warming. Therefore, many countries are carrying out various policies to reduce the amount of VOCs discharged into the air. In the case of the organic solvent, because it is in a liquid phase, the discharge thereof can be easily controlled. However, because the VOC gas is in a gaseous phase, it is very difficult to control the discharge of VOC gas. Meanwhile, a representative example of a part washer which washes parts using organic solvent was proposed in Korean Patent Laid-open Publication No. 2007-0045801 for which a patent application was submitted to the Korean Patent Office on Oct. 28, 2005. However, in the part washer according to this technique, when a cover of a washing tub is opened after washing a part using an organic solvent, a high density of VOC gas is discharged to the air. Furthermore, a large amount of VOC gas which is evaporated from organic solvent in a drum is drawn into the washing tub, thus increasing the density of VOC gas in the washing tub.

### SUMMARY

Accordingly, the present invention has been made keeping in mind the above problems occurring in the prior art, and an object of the present invention is to provide a part washer which is constructed such that when washing a part using organic solvent, the density of VOC gas discharged to the air is minimized by condensing and eliminating the VOC gas.

In order to accomplish the above object, the present invention provides a part washer, including: a drum storing organic solvent therein; a chamber defining a space for placing a part to be washed therein; a first nozzle jetting the organic solvent from the drum onto the part to be washed; and a condensing unit to condense VOC gas.

The part washer may further include: a second nozzle; a VOC gas outlet formed in the chamber; a circulation pipe provided between the second nozzle and the VOC gas outlet such that VOC gas circulates through the VOC gas outlet, the circulation pipe and the second nozzle; and a blowing unit provided on the circulation pipe.

The part washer may further include: a recirculation pipe branching off from the circulation pipe; and a first filter provided on the recirculation pipe.

The part washer may further include: an exhaust pipe branching off from the recirculation pipe; and a second filter provided on the exhaust pipe.

The part washer may further include: a connection pipe connected to a lower end of the chamber, wherein an end of the connection pipe is immersed in the organic solvent in the drum.

The condensing unit may include: a cooling plate fastened to an inner surface of a sidewall of the chamber; and a cover having a VOC gas passage on a lower end thereof, the cover covering the cooling plate.

The first filter may include: a steam sprayer provided in an upper portion of the first filter; and an organic solvent discharge pipe coupled to a lower portion of the first filter.

In order to accomplish the above object, the present invention provides a method of washing a part using a part washer, including: placing the part to be washed in a chamber; sealing the chamber; jetting organic solvent onto the part to be washed; and condensing VOC gas.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view illustrating a part washer, according to an embodiment of the present invention;

FIG. 2 is a perspective view of the part washer of FIG. 1;

FIG. 3 is a sectional view showing an embodiment of a condensing unit according to the present invention;

FIG. 4 is a sectional view showing another embodiment of a condensing unit according to the present invention;

FIG. 5 is a sectional view showing an embodiment of a first filter according to the present invention; and

FIG. 6 is a sectional view showing an embodiment of a second filter according to the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, a preferred embodiment of the present invention will be described in detail with reference to the attached drawings.

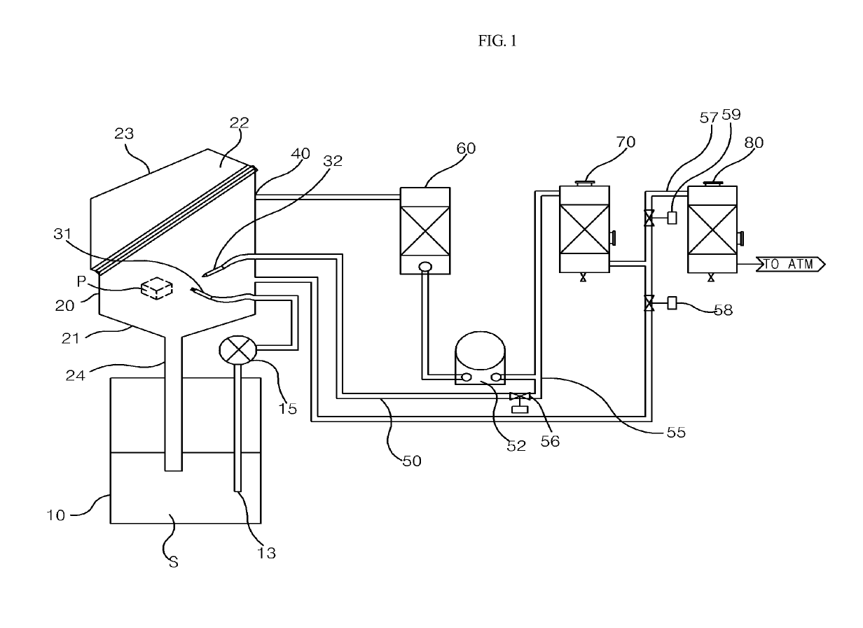

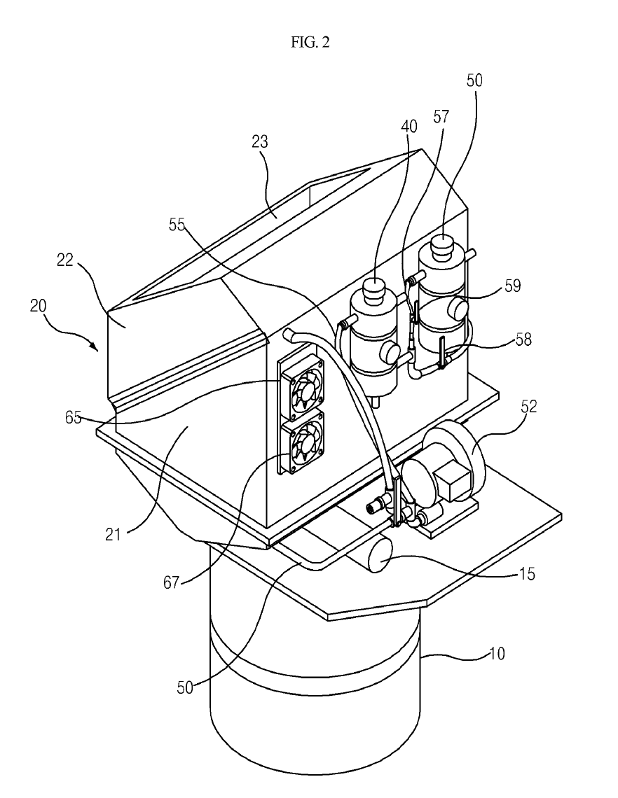

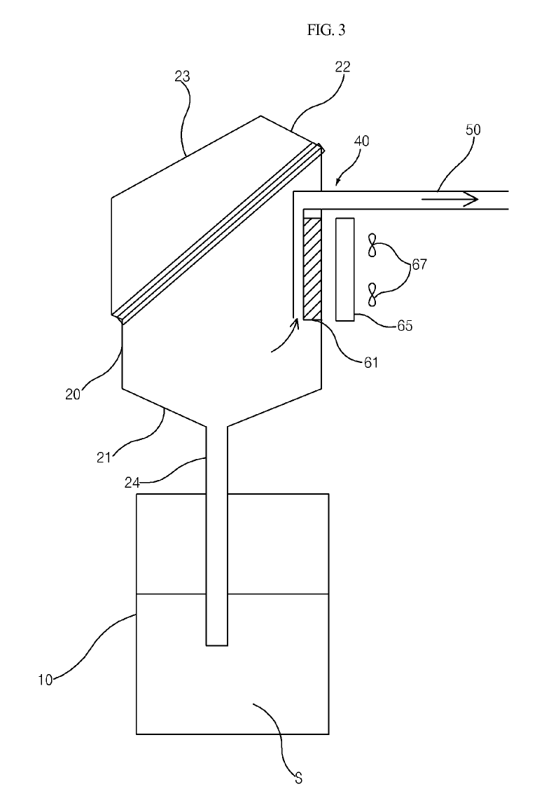

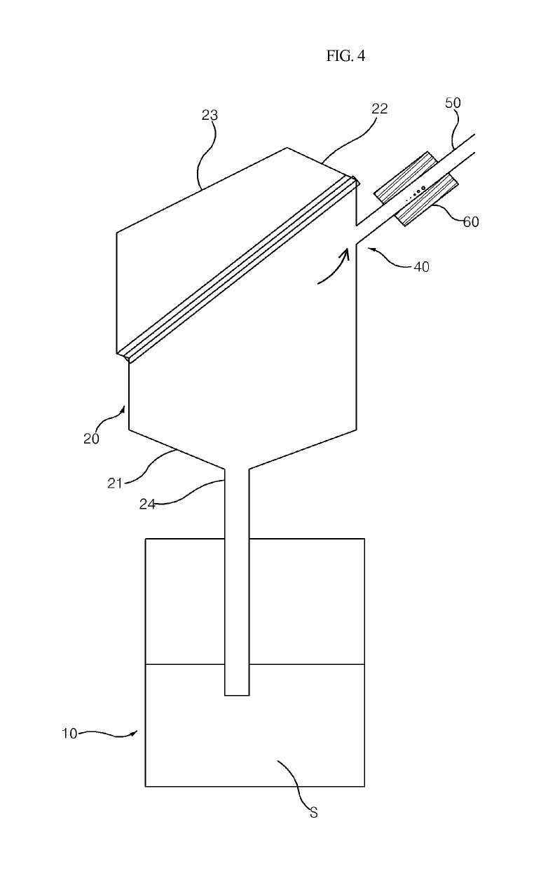

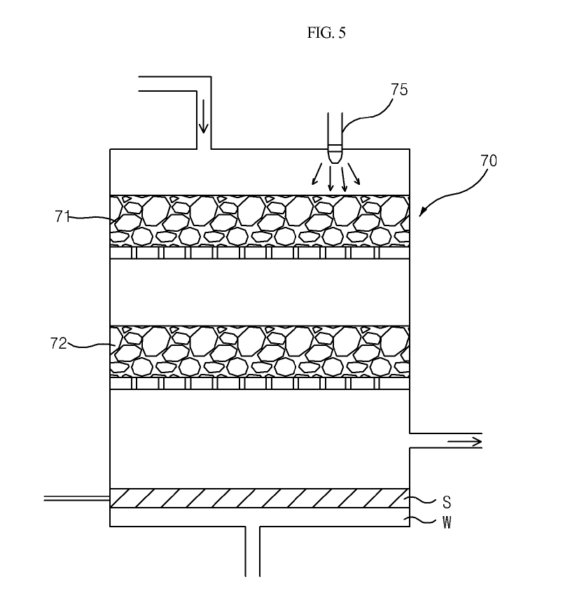

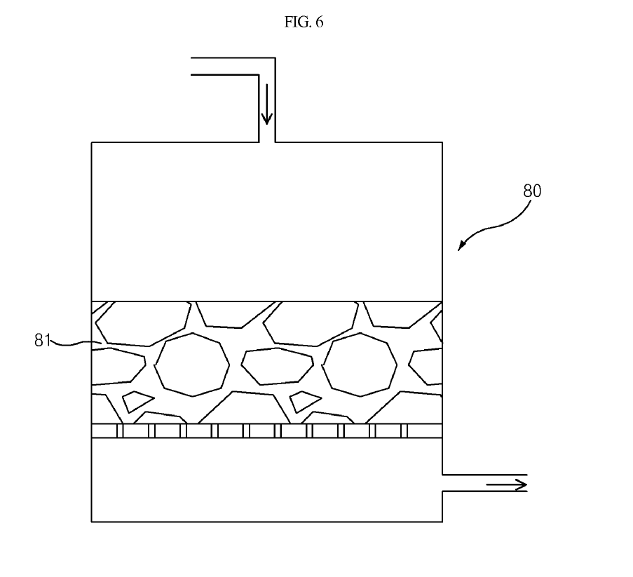

FIG. 1 is a schematic view illustrating a part washer, according to an embodiment of the present invention. FIG. 2 is a perspective view of the part washer of FIG. 1. FIG. 3 is a sectional view showing an embodiment of a condensing unit 60 according to the present invention. FIG. 4 is a sectional view showing another embodiment of a condensing unit 60 according to the present invention. FIG. 5 is a sectional view showing an embodiment of a first filter 70 according to the present invention. FIG. 6 is a sectional view showing an embodiment of a second filter 80 according to the present invention.

As shown in FIGS. 1 and 2, the part washer of the present invention includes a drum 10, a chamber 20, a first nozzle 31 and a condensing unit 60. The drum 10 contains an organic solvent therein. The chamber 20 defines a space for containing a part to be washed. The first nozzle 31 jets organic solvent from the drum 10 onto the part to be washed. The condensing unit 60 condenses VOC gas.

In detail, the drum 10 stores therein an organic solvent S for eliminating oil stains from the part to be washed. The organic solvent S is jetted onto the part P by the first nozzle 31.

When a pump 15 is operated, organic solvent S which has been stored in the drum 10 is drawn into a solvent supply pipe 13 and then jetted onto the part P through the first nozzle 31.

A spray nozzle or a brush nozzle can be used as the first nozzle 31. In the case where the brush nozzle is used, the nozzle can sweep oil stains with a brush when washing the part P.

The chamber 20 includes a bottom surface 21 which has a conical shape. The bottom surface 21 of the chamber 20 is connected to a connection pipe 24 which communicates with the drum 10.

Organic solvent which is formed by condensation of VOC gas in the chamber 20 flows into the drum 10 through the connection pipe 24. Furthermore, the connection pipe 24 extends an appropriate length such that the end thereof is immersed in the organic solvent S that is contained in the drum 10. Therefore, VOC gas which is generated by evaporation of some organic solvent only in the connection pipe 24 is drawn into the chamber 20. Thus, the amount of VOC gas which is directly drawn into the chamber 20 is markedly reduced.

Meanwhile, a cover 22 is provided on the chamber 20, so that the part P to be washed can be put into or removed from the chamber 20 after the cover 22 is opened. Furthermore, a transparent window 23 is formed in the chamber 20 to allow a user to observe the interior of the chamber 20 when washing the part P.

A VOC gas outlet 40 is formed in the chamber 20, so that VOC gas is discharged to the outside of the chamber 20 through the VOC gas outlet 40.

Here, because VOC gas is in a gaseous phase, if it is directly discharged to the air, the problem of air pollution arises. Therefore, the density of VOC gas discharged to the air must be minimized by changing the phase of the VOC gas from a gaseous to a liquid phase.

In the present invention, the condensing unit 60 functions to reduce the density of VOC gas in the chamber 20. In other words, VOC gas is condensed by the condensing unit 60, and organic solvent which is formed by condensing the VOC gas and is in a liquid phase is drawn into the chamber 20.

Referring to FIG. 3, the condensing unit 60 includes a cooling plate 61 and a cover 63. The cooling plate 61 is fastened to the inner surface of the sidewall of the chamber 20. The cover 63 covers the cooling plate 61 and forms a VOC gas passage on the lower end thereof.

The cooling plate 61 is maintained at a low temperature. VOC gas is drawn into the inflow passage which is formed in the lower end of the cover 63 and then flows through a space defined between the cover 63 and the cooling plate 61. Then, the VOC gas is condensed by the cooling plate 61 and is changed in phase, thus forming organic solvent. The organic solvent formed by the condensation of VOC gas flows downwards into the chamber 20.

The condensing unit 60 may further include a chiller. In this case, an expansion plate 65 is provided on the outer surface of the sidewall of the chamber 20, and a fan 67 is disposed behind the expansion plate 65. Meanwhile, as shown in FIG. 4, the condensing unit 60 may be provided on the outer surface of a circulation pipe 50 which extends from the chamber 20 such that it is inclined upwards. Because the circulation pipe 50 is inclined upwards, organic solvent which is formed by condensation of VOC gas flows downwards along the circulation pipe 50 and then enters the chamber 20.

Meanwhile, VOC gas which is in the circulation pipe 50 is forcibly circulated by a blowing unit 52, such as a blower fan. A second nozzle 32 is connected to the circulation pipe 50. The second nozzle 32 functions to remove organic solvent from the part P to be washed.

A recirculation pipe 55 branches off from the circulation pipe 50. More preferably, the recirculation pipe 55 branches off from the portion of the circulation pipe 50 between the blowing unit 52 and the second nozzle 32. The end of the recirculation pipe 55 is connected to the second nozzle 32 or the sidewall of the chamber 20. As shown in FIG. 1, in the case where the end of the recirculation pipe 55 is connected to the second nozzle 32, VOC gas is jetted onto the part P through the second nozzle 32 in the chamber 20 after passing through a first filter 70 such that the density thereof is reduced. In the case where the end of the recirculation pipe 55 is connected to the sidewall of the chamber 20 rather than being connected to the second nozzle 32, VOC gas is drawn into the chamber 20 after passing through the first filter 70 such that the density thereof is reduced.

Furthermore, a first valve 56 is provided on the circulation pipe 50. Thus, when the first valve 56 is closed, VOC gas flows through the recirculation pipe 55. The first filter 70 is provided on the recirculation pipe 55.

Referring to FIG. 5, the first filter 70 includes a charcoal filter 71 and a bio-ceramic filter 72. VOC gas is primarily filtered by the charcoal filter 71. When VOC gas passes through the bio-ceramic filter 72 which contains microbes therein, the microbes eat VOC gas, thus secondarily reducing the density of VOC gas.

The bio-ceramic filter 72 has a granular or planar structure.

Furthermore, the first filter 70 further includes a steam sprayer 75. The steam sprayer 75 supplies water to the microbes and changes VOC gas into a liquid phase. The steam sprayer 75 also functions to wash the charcoal filter 71 such that the charcoal filter 71 can be consecutively used. In addition, because water is supplied to microbes, the bio-ceramic filter 72 can be semi-permanently used.

Steam which is sprayed from the steam sprayer 75 is condensed and collected in the lower portion of the first filter 70. Organic solvent S is also collected in the lower portion of the first filter 70. Here, because of a difference in density between water W and organic solvent S, the water W and the organic solvent S form layers.

Thus, the organic solvent S which forms an upper layer is drawn into the drum 10 or the chamber 20 through an organic solvent discharge pipe. As well, the water W is discharged outside through a valve provided in the lower end of the first filter 70.

Furthermore, an exhaust pipe 57 branches off from the recirculation pipe 55. More preferably, the exhaust pipe 57 branches off from the recirculation pipe 55 between the first filter 70 and the second nozzle 32. A second filter 80 is provided on the exhaust pipe 57.

Referring to FIG. 6, the second filter 80 includes a bio-ceramic filter 81. VOC gas which flows through the exhaust pipe 57 passes through the second filter 80 such that the density of VOC gas is reduced, and thereafter, it is exhausted to the air.

A method of washing the part P using the part washer according to the present invention will be explained below. The cover 22 is opened. The part P to be washed is disposed in the chamber 20. Thereafter, the pump 15 is operated, so that organic solvent is jetted from the first nozzle 31 onto the part P to remove oil stains from the part P.

Furthermore, the blowing unit 52 is operated to forcibly circulate VOC gas which is in the chamber 20, so that the gas is jetted onto the part P through the second nozzle 32, thus removing organic solvent from the part P.

Subsequently, the first valve 56 is closed such that VOC gas which has passed through the circulation pipe 50 is drawn into the recirculation pipe 55. The VOC gas which flows through the recirculation pipe 55 passes through the first filter 70 and then enters the chamber 20 again.

After two or three minutes have passed, the second valve 58 is closed and the third valve 59 is opened. Then, VOC gas which has passed through the recirculation pipe 55 is drawn into the exhaust pipe 57.

The VOC gas which flows through the exhaust pipe 57 passes through the second filter 80 and then is exhausted to the air. Thereafter, the user opens the cover 22 and pulls the part P out of the chamber 20.

As a modification of the part washer according to the present invention, water may be used in place of organic solvent. The condensing unit functions to condense harmful gas generated when washing the part P.

As another modification of the part washer according to the present invention, a heating unit may be provided on the drum. In this case, the heating unit prevents an organic solvent from freezing. Thus, the part washer according to this modification can be reliably used even in cold areas.

As described above, a part washer and a part washing method according to the present invention can be used to remove oil stains from a part using an organic solvent.

The part washer according to the present invention has the following advantages:

VOC gas which is generated in a chamber is condensed, so that the density of VOC gas in the chamber is reduced;

furthermore, the VOC gas passes through a first filter provided on a recirculation pipe, so that the density of VOC gas is further reduced;

in addition, the VOC gas passes through a second filter provided on an exhaust pipe, so that the density of VOC gas is further reduced;

as well, a connection pipe is installed such that the end thereof is immersed in an organic solvent that is stored in the drum. Hence, the amount of VOC gas drawn from the drum into the chamber is reduced.

In conclusion the present invention does not affect the health of a user and can prevent air pollution.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A part washer, comprising:
a drum storing organic solvent therein;
a chamber defining a space for placing a part to be washed therein;
a first nozzle jetting the organic solvent from the drum onto the part to be washed; and
a condensing unit to condense VOC (volatile organic compounds) gas.

2. The part washer as set forth in claim 1, further comprising:
a second nozzle;
a VOC gas outlet formed in the chamber;
a circulation pipe provided between the second nozzle and the VOC gas outlet such that VOC gas circulates through the VOC gas outlet, the circulation pipe and the second nozzle; and
a blowing unit provided on the circulation pipe.

3. The part washer as set forth in claim 1, further comprising:
a recirculation pipe branching off from the circulation pipe; and
a first filter provided on the recirculation pipe.

4. The part washer as set forth in claim 3, further comprising:
an exhaust pipe branching off from the recirculation pipe; and
a second filter provided on the exhaust pipe.

5. The part washer as set forth in claim 1, further comprising:
a connection pipe connected to a lower end of the chamber,
wherein an end of the connection pipe is immersed in the organic solvent in the drum.

6. The part washer as set forth in claim 1, wherein the condensing unit comprises:
a cooling plate fastened to an inner surface of a sidewall of the chamber; and
a cover having a VOC gas passage on a lower portion thereof, the cover covering the cooling plate.

7. The part washer as set forth in claim 3, wherein the first filter comprises:
a steam sprayer provided in an upper portion of the first filter; and
an organic solvent discharge pipe coupled to a lower portion of the first filter.

8. A method of washing a part using a part washer, comprising:
placing the part to be washed in a chamber;
sealing the chamber;
to jetting organic solvent onto the part to be washed; and
condensing VOC gas.
